(19) United States
(12) Patent Application Publication
(10) Pub. No.: US 2022/0063549 A1
(43) Pub. Date: Mar. 3, 2022

(54) SIDE AIRBAG APPARATUS AND METHOD FOR MANUFACTURING THE SAME

(71) Applicant: HYUNDAI MOBIS CO., LTD., Seoul (KR)

(72) Inventor: Geum Dong KIM, Yongin-si (KR)

(73) Assignee: HYUNDAI MOBIS CO., LTD., Seoul (KR)

(21) Appl. No.: 17/412,071

(22) Filed: Aug. 25, 2021

(30) Foreign Application Priority Data
Aug. 26, 2020 (KR) 10-2020-0107729

(51) Int. Cl. B60R 21/2338; B60R 21/21; B60R 21/231; B60R 21/233; B60R 21/26

(52) U.S. Cl. CPC B60R 21/2338; B60R 21/21; B60R 2021/0041; B60R 21/233; B60R 21/26; B60R 21/23138

(57) ABSTRACT

A side airbag apparatus may include: an inflator configured to discharge gas; and a cushion deployed to one side of a passenger by the gas discharged from the inflator, and having a main chamber and a push chamber, which are formed therein, wherein the push chamber is inflated to protrude from the main chamber toward an indoor side, and pushes up an arm the passenger, wherein the cushion comprises a first panel disposed at a side surface of a vehicle body; a second panel stacked on an indoor side of the first panel, and configured to form the main chamber and the push chamber with the first panel; and a tether member inserted between the first and second panels, having one end coupled to the first panel and the other end coupled to the second panel.

### CROSS-REFERENCE TO RELATED APPLICATION

This application claims the benefit under 35 U.S.C. § 119(a) of Korean Patent Application No. 10-2020-0107729 filed on Aug. 26, 2020 in the Korean Intellectual Property Office, the entire disclosure of which is incorporated herein by reference for all purposes.

### BACKGROUND

### Field

Exemplary embodiments of the present disclosure relate to a side airbag apparatus and a method for manufacturing the same, and more particularly, to a side airbag apparatus which can minimize damage to the body of a passenger in case of a side collision of a vehicle, and a method for manufacturing the same.

### Discussion of the Background

In general, a vehicle includes airbags installed to protect a passenger. The airbags are disposed at various places according to body parts of the passenger, which are to be protected. A side airbag is disposed outside a seat.

In case of a side collision of a vehicle, gas is injected into the side airbag. The side airbag is inflated by the gas, and buffers and protects the outside of the passenger.

According to the collision test-related regulations in each country, the shape of a dummy serving as a test object may be changed. When the shape of the dummy is changed so that the dummy's arm further droops, the arm and body of the dummy are positioned almost in parallel to each other. As the arm and body of the dummy are positioned in parallel to each other, the space between the arm of the dummy and a side surface of a vehicle body is narrowed. In this case, when the side airbag is inflated, the arm is stuck between the side airbag and the body, and the inflation pressure of the side airbag causes the arm to press the chest of the dummy. Therefore, the chest of the passenger may be damaged by the inflation pressure of the side airbag.

The related art of the present disclosure is disclosed in Korean Patent No. 10-1305870 registered on Sep. 2, 2013 and entitled “Side Airbag Apparatus for Vehicle”.

### SUMMARY

Various embodiments are directed to a side airbag apparatus which can minimize damage to the body of a passenger by an arm of the passenger in case of a side collision of a vehicle, and a method for manufacturing the same.

Also, various embodiments are directed to a side airbag apparatus which can secure a sufficient space outside the body of a passenger, such that a cushion can be inflated in the thickness direction of the cushion, and thus minimize damage to the chest of the passenger by inflation pressure of the cushion, and a method for manufacturing the same.

Also, various embodiments are directed to a side airbag apparatus which can minimize the interference with a passenger's arm such that a cushion is stably deployed to one side of the passenger and safely protects the passenger, and a method for manufacturing the same.

In an embodiment, a side airbag apparatus may include: an inflator configured to discharge gas; and a cushion deployed to one side of a passenger by the gas discharged from the inflator, and having a main chamber and a push chamber, which are formed therein. The push chamber may be inflated to protrude from the main chamber toward an indoor side, and push up an arm the passenger. The cushion may include: a first panel disposed at a side surface of a vehicle body; a second panel stacked on an indoor side of the first panel, and configured to form the main chamber and the push chamber with the first panel; and a tether member inserted between the first and second panels, having one end coupled to the first panel and the other end coupled to the second panel, and configured to form the push chamber by pulling the second panel when the cushion is deployed.

The tether member may include: a body part; a first sewed part provided at one end of the body part, and sewed to the first panel; and a second sewed part provided at the other end of the body part, and sewed to the second panel. The height at which the second sewed part is sewed to the second panel may be higher than the height at which the first sewed part is sewed to the first panel.

The tether member may be provided at a position higher than centers of the first and second panels.

The body part may be formed in a plate shape.

When a thickness of the cushion in a direction from the first panel to second panel during the deployment of the cushion is referred to as an inflation thickness, the tether member may be formed to have a smaller length than the inflation thickness of a lower region of the cushion during the deployment of the cushion.

When the cushion is deployed, a push surface may be formed at a surface of the second panel, facing an indoor side, by tension of the tether member, and formed at a top of the push chamber so as to face upward. When the push chamber is inflated, the push surface may push up the arm of the passenger.

In an embodiment, a method for manufacturing a side airbag apparatus may include: a first step of preparing a first panel and a second panel which is to be disposed in a direction facing a passenger from the first panel, when a cushion is deployed; a second step of coupling one end of a tether member to the first panel, and coupling the other end of the tether member to the second panel; and a third step of overlapping the first and second panels such that the tether member is interposed between the first and second panels, and then sewing edges of the first and second panels, wherein when the cushion is deployed, a push chamber is formed at a lower region of the cushion by tension of the tether member, and inflated to protrude and push up an arm of the passenger.

In the second step, the tether member may be coupled to the first and second panels, such that one end thereof is disposed at a higher position than the other end thereof.

In accordance with the embodiments of the present disclosure, when the push chamber is inflated, the push surface may push up the arm of the passenger, which makes it possible to prevent the arm of the passenger from being stuck between the body of the passenger and the vehicle body. Thus, it is possible to minimize an injury to the body of the passenger, which is applied by to the arm of the passenger, in case of a side collision.

Furthermore, as the arm of the passenger is pushed up by the inflation of the push chamber, a space corresponding to the thickness of the arm may be further formed on one side of the passenger. Thus, since a sufficient space is secured outside the body of the passenger such that the cushion can be inflated in the thickness direction thereof, it is possible to minimize an injury to the chest of the passenger by the inflation pressure of the cushion.

Furthermore, since the interference of an arm is minimized when the cushion is inflated, the cushion may be stably deployed to one side of the passenger, thereby safely protecting the passenger.

### BRIEF DESCRIPTION OF THE DRAWINGS

FIG. 1 is a diagram illustrating a side airbag apparatus in accordance with an embodiment of the present disclosure.

FIG. 2 is a diagram illustrating that a cushion in accordance with the embodiment of the present disclosure is unfolded.

FIG. 3 is a diagram illustrating a tether member in accordance with the embodiment of the present disclosure.

FIG. 4 is a cross-sectional view taken along the line A-A of FIG. 1.

FIG. 5 is a cross-sectional view illustrating that the cushion in accordance with the embodiment of the present disclosure is inflated.

FIG. 6 is a front view illustrating that a push chamber pushes up an arm while the cushion in accordance with the embodiment of the present disclosure is deployed.

### DETAILED DESCRIPTION OF THE ILLUSTRATED EMBODIMENTS

Hereafter, embodiments of the present disclosure will be described in detail with reference to the accompanying drawings.

First, the following embodiments are embodiments suitable for promoting understandings of the technical features of a side airbag apparatus and a method for manufacturing the same in accordance with the present disclosure. However, the present disclosure is not limited to the following embodiments, the technical features of the present disclosure are not limited by the following embodiments, and the present disclosure can be modified in various manners without departing from the scope of the present disclosure.

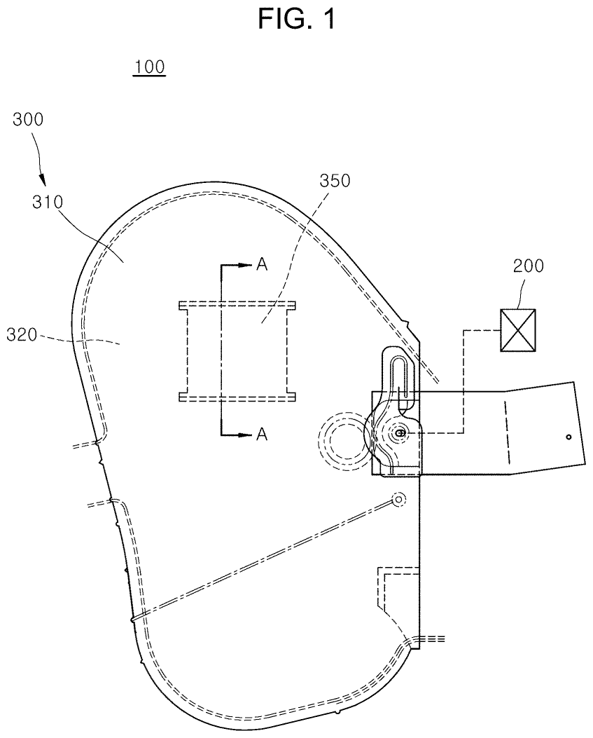

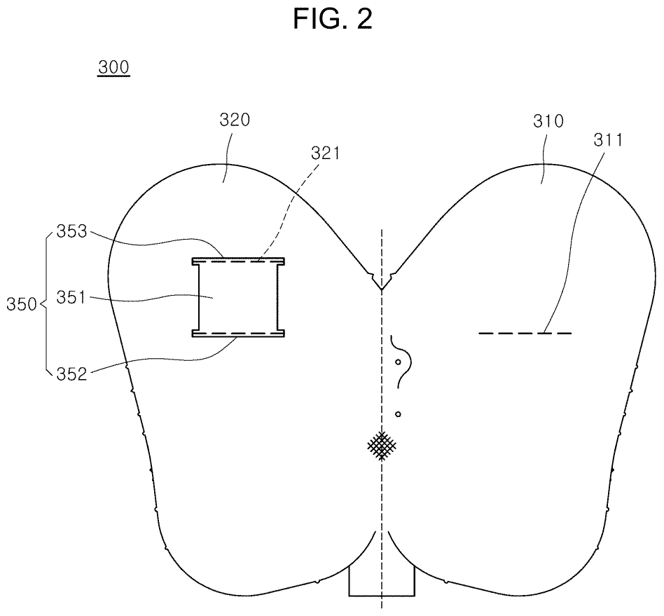

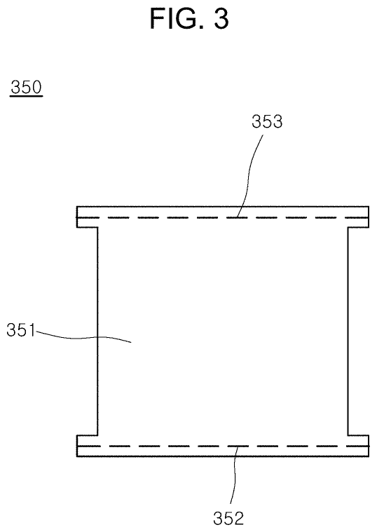

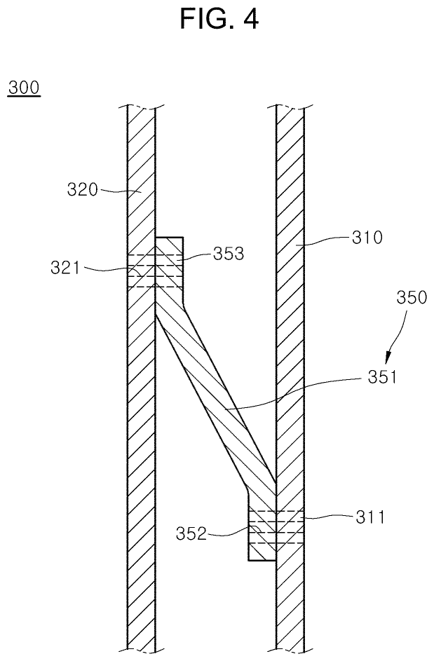

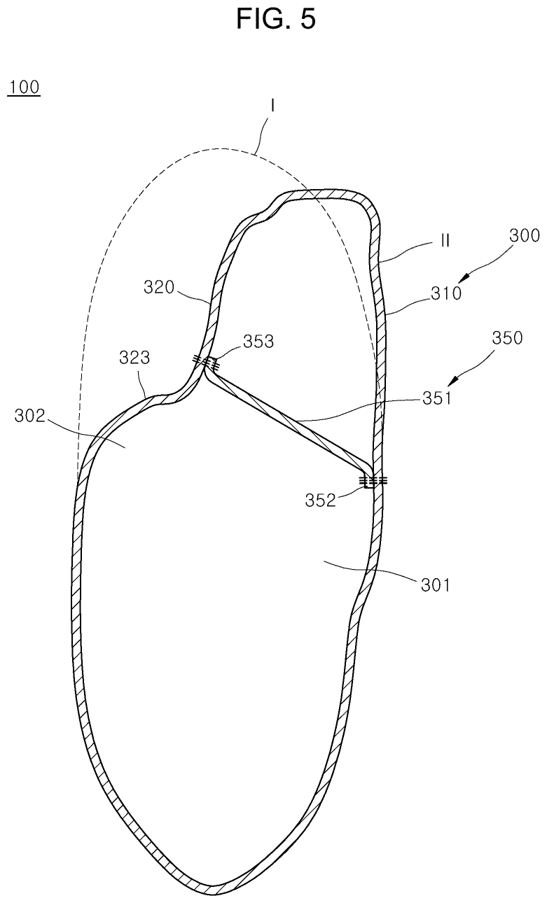

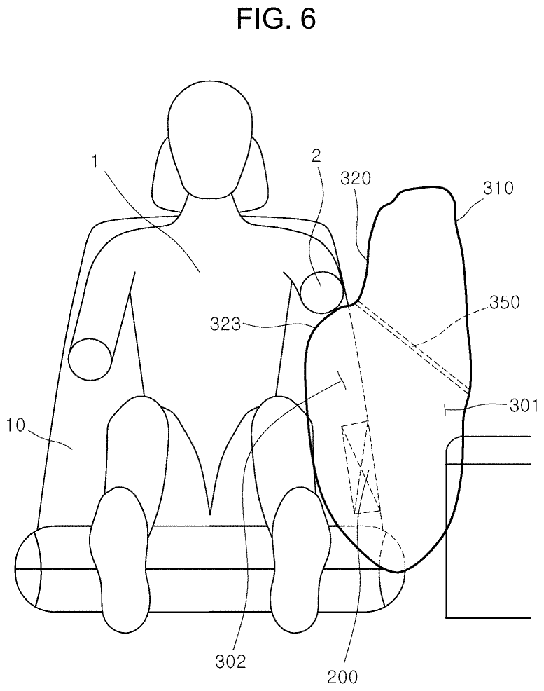

FIG. 1 is a diagram illustrating a side airbag apparatus in accordance with an embodiment of the present disclosure, FIG. 2 is a diagram illustrating that a cushion in accordance with the embodiment of the present disclosure is unfolded, FIG. 3 is a diagram illustrating a tether member in accordance with the embodiment of the present disclosure, FIG. 4 is a cross-sectional view taken along the line A-A of FIG. 1, FIG. 5 is a cross-sectional view illustrating that the cushion in accordance with the embodiment of the present disclosure is inflated, and FIG. 6 is a front view illustrating that a push chamber pushes up an arm while the cushion in accordance with the embodiment of the present disclosure is deployed.

Referring to FIGS. 1 to 6, a side airbag apparatus 100 in accordance with the embodiment of the present disclosure includes an inflator 200 and a cushion 300.

The inflator 200 is provided to discharge gas. For example, the inflator 200 may be mounted on a seat part 10. The inflator 200 may be installed at a necessary position of the seat part 10 of each seat, on which a passenger 1 is seated. For example, the inflator 200 may be installed in a seat back 11 of the seat part 10, but the present disclosure is not limited thereto.

The cushion 300 is deployed to one side of a passenger 1 by the gas discharged from the inflator 200. When the cushion 300 is inflated, a main chamber 301 and a push chamber 302 may be formed in the cushion 300. The push chamber 302 is inflated to protrude from the main chamber 301 toward the indoor side of the vehicle, thereby pushing up an arm of the passenger 1.

The side airbag apparatus 100 in accordance with the embodiment of the present disclosure may be a side airbag apparatus 100 which is deployed between the passenger 1 and a door of the vehicle in case of a collision of the vehicle, for example, and controls the behavior of the passenger 1 so as to protect the passenger 1.

In case of a collision of the vehicle, the cushion 300 may be inflated and deployed in a lateral direction, and prevent a collision between the passenger 1 and the vehicle, thereby protecting the passenger 1. For example, the cushion 300 applied to the side airbag apparatus in accordance with the embodiment of the present disclosure serves to control the behavior of the body of the passenger 1.

When gas is supplied from the inflator 200, the main chamber 301 and the push chamber 302 may be formed in the cushion 300. The main chamber 301 may be deployed perpendicular to the lateral direction of the passenger 1, and the push chamber 302 may be inflated to protrude from the main chamber 301 toward the passenger 1. At this time, the push chamber 302 may be inflated to push up the arm of the passenger 1.

Specifically, the cushion 300 may include a first panel 310, a second panel 320 and a tether member 350.

The first and second panels 310 and 320 may be disposed to overlap each other, and the edges thereof may be sewed and coupled. The first and second panels 310 and 320 may be connected and formed as one member, and formed symmetrically with each other. However, the first and second panels 310 and 320 are not limited thereto, but may be provided as separate members. Between the first and second panels 310 and 320, the main chamber 301 and the push chamber 302 may be formed. The main chamber 301 and the push chamber 302 may communicate with each other. That is, the main chamber 301 and the push chamber 302 may be disposed in different regions of one chamber space.

The first panel 310 may be disposed at a side surface of the vehicle body, and the second panel 320 may be stacked on the indoor side of the first panel 310. That is, when the cushion 300 is deployed, the first panel 310 may be disposed on the outboard side, and the second panel 320 may be disposed on the inboard side corresponding to the opposite side of the outboard side and facing the passenger 1. The push chamber 302 may be inflated to protrude, while the shape of the second panel 320 is changed.

The tether member 350 may be inserted between the first and second panels 310 and 320, and have one end coupled to the first panel 310 and the other end coupled to the second panel 320. The tether member 350 may be configured to form the push chamber 302 by pushing the second panel 320, when the cushion 300 is deployed.

Specifically, the tether member 350 serving as a component for forming the push chamber 302 in the cushion 300 may be attached to surfaces of the first and second panels 310 and 320, facing each other. The tether member 350 may form the push chamber 302 by controlling the deployment shape of the upper region of the cushion 300.

More specifically, the tether member 350 may include a body part 351, a first sewed part 352 and a second sewed part 353.

The body part 351 constitutes the body of the tether member 350, and generates tension when the cushion 300 is deployed. For example, the body part 351 may be formed as a plate-shaped member as illustrated in the drawings. Thus, the body part 351 may be reliably coupled to the first and second panels 310 and 320. However, the shape of the body part 351 is not limited thereto, but may be changed to various shapes.

The first sewed part 352 may be provided at one end of the body part 351, and sewed to the first panel 310. The second sewed part 353 may be provided at the other end of the body part 351, and sewed to the second panel 320.

The height at which the second sewed part 353 is sewed to the second panel 320 may be higher than the height at which the first sewed part 352 is sewed to the first panel 310. The first panel 310 may have a first sewing line 311 corresponding to the first sewed part 352, and the second panel 320 may have a second sewing line 321 corresponding to the second sewed part 353. The second sewing line 321 may be formed at a higher position than the first sewing line 311.

Thus, when the cushion 300 is inflated, the tether member 350 may be inclined downward toward the second panel 320 from the first panel 310.

The tether member 350 may be provided at a higher position than the centers of the first and second panels 310 and 320. That is, the tether member 350 may be coupled to the upper region of the cushion 300. Thus, when the cushion 300 is deployed, the tether member 350 may control the shape of the upper region of the cushion 300.

Specifically, the tether member 350 may be provided at the upper region of the cushion 300, and the other end of the tether member 350, facing the second panel 320, may be formed at a higher position than the one end thereof, facing the first panel 310. Thus, when the cushion 300 is deployed, the second panel 320 may be pulled by the tether member 350, such that an L-shaped curved portion is formed in the second panel 320 (see FIG. 5).

Furthermore, the push chamber 302 may be formed in the cushion 300. While the shape of the second panel 320 is changed by the tension of the tether member 350, the push chamber 302 may protrude toward the passenger 1. In a comparative example, when both ends of the tether member 350 are coupled to have the same height in the case that the tether member 350 is attached to the first and second panels 310 and 320, the first and second panels 310 and 320 may be symmetrical with each other while the cushion 300 is inflated. Therefore, the second panel 320 may not be deformed in a curved shape.

However, the tether member 350 in accordance with the embodiment of the present disclosure may be inclined downward toward the first panel 310, and thus form a push inflation part by pulling the second panel 320 downward.

The thickness of the cushion 300 in the direction from the first panel 310 to the second panel 320 during the deployment of the cushion 300 may be referred to as an inflation thickness. In this case, when the cushion 300 is deployed, the tether member 350 may have a smaller length than the inflation thickness of the lower region of the cushion 300.

Thus, as the tension is generated when the cushion 300 is inflated, the tether member 350 may change the shape of the second panel 320 by pulling the second panel 320.

Specifically, when the cushion 300 is deployed, a push surface 323 may be formed at a surface of the second panel 320, facing the indoor side, by the tension of the tether member 350, and formed at the top of the push chamber 302 so as to face upward. When the push chamber 302 is inflated, the push surface 323 may be formed to push up an arm of the passenger 1.

Specifically, referring to FIG. 5, the conventional cushion 300 may be deployed in an elliptical shape such that the first and second panels 310 and 320 are symmetrical with each other (see symbol I). In the present disclosure, however, when the cushion 300 is deployed, the push chamber 302 may be formed to protrude from the main chamber 301. Thus, the push surface 323 may be formed while the second panel 320 is deformed in a curved shape (see symbol II).

That is, as the second panel 320 is deformed in a stepped shape, the push surface 323 may be formed to face upward. As the push inflation part is inflated, the push surface 323 may be moved upward. By using such a cushion deployment force, the side airbag apparatus 100 may raise the arm of the passenger 1 in a vertical direction.

At this time, the height at which the arm of the passenger 1 is raised may be decided according to the deployment force of the cushion 300, the mounting position of the tether member 350, and the length of the tether member 350. Therefore, depending on the environment where the side airbag apparatus 100 is mounted, the position and length of the tether member 350 may be adjusted to raise the arm of the passenger 1 to a proper height.

Hereafter, a method for manufacturing a side airbag apparatus in accordance with an embodiment of the present disclosure will be described. The method for manufacturing a side airbag apparatus in accordance with the embodiment of the present disclosure is a method for manufacturing the above-described side airbag apparatus 100 in accordance with the embodiment of the present disclosure, and the overlapping descriptions of the same components will be omitted.

The method for manufacturing the side airbag apparatus 100 in accordance with the embodiment of the present disclosure may include a first step, a second step and a third step.

In the first step, the first panel 310 and the second panel 320 are prepared. The second panel 320 is disposed in a direction facing the passenger 1 from the first panel 310, when the cushion 300 is deployed.

In the second step, one end of the tether member 350 is coupled to the first panel 310, and the other end of the tether member 350 is coupled to the second panel 320.

Specifically, in the second step, the first sewed part 352 of the tether member 350 may be sewed to the first sewing line 311 of the first panel 310. Furthermore, the second sewed part 353 of the tether member 350 may be sewed to the second sewing line 321 of the second panel 320.

In the second step, the tether member 350 may be coupled to the first and second panels 310 and 320 such that one end thereof is located at a higher position than the other end thereof. Thus, when the cushion 300 is inflated, the tether member 350 may pull the second panel 320 in a downward diagonal direction.

In the third step, the first and second panels 310 and 320 are disposed to overlap each other, such that the tether member 350 is interposed between the first and second panels 310 and 320, and the edges of the first and second panels 310 and 320 are sewed.

Then, the cushion 300 and the inflator 200 may be connected to each other, and the cushion 300 may be folded and stored in the seat part 10.

Furthermore, when the cushion 300 is deployed, the push chamber 302 may be formed at the lower region of the cushion 300 by the tension of the tether member 350, and inflated to protrude and push up the arm of the passenger 1.

When the side airbag apparatus and the method for manufacturing the same in accordance with the embodiments of the present disclosure are used, the push surface may push up the arm of the passenger in case that the push chamber is inflated, which makes it possible to prevent the arm of the passenger from being stuck between the body of the passenger and the vehicle body. Thus, it is possible to minimize an injury to the body of the passenger, which is applied by to the arm of the passenger, in case of a side collision.

Furthermore, as the arm of the passenger is pushed up by the inflation of the push chamber, a space corresponding to the thickness of the arm may be further formed on one side of the passenger. Thus, since a sufficient space is secured outside the body of the passenger such that the cushion can be inflated in the thickness direction thereof, it is possible to minimize an injury to the chest of the passenger by the inflation pressure of the cushion.

Furthermore, since the interference of an arm is minimized when the cushion is inflated, the cushion may be stably deployed to one side of the passenger, thereby safely protecting the passenger.

Although exemplary embodiments of the disclosure have been disclosed for illustrative purposes, those skilled in the art will appreciate that various modifications, additions and substitutions are possible, without departing from the scope and spirit of the disclosure as defined in the accompanying claims. Thus, the true technical scope of the disclosure should be defined by the following claims.

What is claimed is:

1. A side airbag apparatus comprising:
an inflator configured to discharge gas; and
a cushion deployed to one side of a passenger by the gas discharged from the inflator, and having a main chamber and a push chamber, which are formed therein, wherein the push chamber is inflated to protrude from the main chamber toward an indoor side, and pushes up an arm the passenger,
wherein the cushion comprises:
a first panel disposed at a side surface of a vehicle body;
a second panel stacked on an indoor side of the first panel, and configured to form the main chamber and the push chamber with the first panel; and
a tether member inserted between the first and second panels, having one end coupled to the first panel and another end coupled to the second panel, and configured to form the push chamber by pulling the second panel when the cushion is deployed.

2. The side airbag apparatus of claim 1, wherein the tether member comprises:
a body part;
a first sewed part provided at one end of the body part, and sewed to the first panel; and
a second sewed part provided at another end of the body part, and sewed to the second panel,
wherein a height at which the second sewed part is sewed to the second panel is higher than the height at which the first sewed part is sewed to the first panel.

3. The side airbag apparatus of claim 2, wherein the tether member is provided at a position higher than centers of the first and second panels.

4. The side airbag apparatus of claim 2, wherein the body part is formed in a plate shape.

5. The side airbag apparatus of claim 1, wherein when a thickness of the cushion in a direction from the first panel to second panel during the deployment of the cushion is an inflation thickness, the tether member is formed to have a smaller length than the inflation thickness of a lower region of the cushion during the deployment of the cushion.

6. The side airbag apparatus of claim 1, wherein when the cushion is deployed, a push surface is formed at a surface of the second panel, facing an indoor side, by tension of the tether member, and formed at a top of the push chamber so as to face upward,
wherein when the push chamber is inflated, the push surface pushes up the arm of the passenger.

7. A method for manufacturing a side airbag apparatus, comprising:
a first step of preparing a first panel and a second panel which is to be disposed in a direction facing a passenger from the first panel, when a cushion is deployed;
a second step of coupling one end of a tether member to the first panel, and coupling another end of the tether member to the second panel; and
a third step of overlapping the first and second panels such that the tether member is interposed between the first and second panels, and then sewing edges of the first and second panels,
wherein when the cushion is deployed, a push chamber is formed at a lower region of the cushion by tension of the tether member, and inflated to protrude and push up an arm of the passenger.

8. The method of claim 7, wherein in the second step, the tether member is coupled to the first and second panels, such that one end thereof is disposed at a higher position than another end thereof.
